(19) United States
(12) Patent Application Publication
(10) Pub. No.: US 2021/0063682 A1
(43) Pub. Date: Mar. 4, 2021

(54) OPTICAL-COMPONENT SUPPORTING APPARATUS, OPTICAL-COMPONENT DRIVING APPARATUS, CAMERA APPARATUS, AND ELECTRONIC DEVICE

(71) Applicant: New Shicoh Motor Co., Ltd., Zhejiang (CN)

(72) Inventor: Kokichi Terajima, Kanagawa (JP)

(21) Appl. No.: 17/003,080

(22) Filed: Aug. 26, 2020

(30) Foreign Application Priority Data
Sep. 3, 2019 (CN) 201910827754.7

(51) Int. Cl. G02B 7/09; G03B 13/36; G02B 27/64; G03B 5/00

(52) U.S. Cl. CPC G02B 7/09; G03B 13/36; G03B 2205/0015; G03B 5/00; G02B 27/646

(57) ABSTRACT

Provided are an optical-component supporting apparatus capable of stably supporting an optical component with respect to a linear movement along an optical axis direction and a pivoting action, an optical-component driving apparatus, a camera apparatus, and an electronic device. The optical-component supporting apparatus (12) includes: a supporting magnet (28), which has a columnar shape, and is magnetized in an axis direction; a first support member (14), which has the supporting magnet (28) fixed at a center, and includes an outer peripheral surface (24) parallel to the axis direction; a second support member (16), which is provided around the first support member (14), and includes an inner peripheral surface (32) that is opposed to the first support member (14) and is parallel to the axis direction; and intermediate support members (36, 38), which are inserted into a space (34) defined between the outer peripheral surface (24) of the first support member (14) and the inner peripheral surface (32) of the second support member (16), and are magnetized by the supporting magnet (28), wherein a width of the space (34) as seen from the axis direction increases in a circumferential direction from portions having a width that allows the intermediate support members (36, 38) to be sandwiched.

### BACKGROUND OF THE INVENTION

### 1. Field of the Invention

The present invention relates to an optical-component supporting apparatus, an optical-component driving apparatus, a camera apparatus, and an electronic device.

### 2. Description of the Related Art

As a focusing mechanism for a camera apparatus, there has been known a focusing mechanism configured to move an image sensor in an optical axis direction of a lens. In Japanese Patent Application Laid-open No. 2004-004253, there is disclosed a configuration of an optical-component supporting apparatus in which an image sensor is supported by an elastic member, which is provided between a bottom surface of the image sensor and an upper side surface of an apparatus main body.

### SUMMARY OF THE INVENTION

As disclosed in the related-art example described above, the related-art optical-component supporting apparatus is configured to support optical components such as the image sensor with use of the elastic member. Therefore, there is a problem in that a static posture and a dynamic posture of the optical component with respect to an optical axis are less likely to be stabilized during a linear movement along the optical axis direction and a pivoting action.

The present invention has been made to solve the problem of the related art described above, and has an object to provide an optical-component supporting apparatus capable of stably supporting an optical component with respect to a linear movement along an optical axis direction and a pivoting action, an optical-component driving apparatus, a camera apparatus, and an electronic device.

According to one mode of the present invention, there is provided an optical-component supporting apparatus. The optical-component supporting apparatus includes: a supporting magnet, which has a columnar shape, and is magnetized in an axis direction; a first support member, which has the supporting magnet fixed at a center, and includes an outer peripheral surface parallel to the axis direction; a second support member, which is provided around the first support member, and includes an inner peripheral surface that is opposed to the first support member and is parallel to the axis direction; and intermediate support members, which are inserted into a space defined between the outer peripheral surface of the first support member and the inner peripheral surface of the second support member, and are magnetized by the supporting magnet, wherein a width of the space as seen from the axis direction increases in a circumferential direction from portions having a width that allows the intermediate support members to be sandwiched.

The outer peripheral surface of the first support member and the inner peripheral surface of the second support member may each be a curved surface, or may each have a polygonal shape as seen from the axis direction. It is preferred that the outer peripheral surface of the first support member have a regular polygonal shape as seen from the axis direction and that the inner peripheral surface of the second support member have a polygonal shape as seen from the axis direction, in which lengths of sides adjacent to each other are different from each other and in which the number of corners is the same as the number of corners of the outer peripheral surface of the first support member. Moreover, in contrast, the outer peripheral surface of the first support member may have a polygonal shape as seen from the axis direction, in which lengths of sides adjacent to each other are different from each other, and the inner peripheral surface of the second support member may have a regular polygonal shape.

The outer peripheral surface of the first support member and the inner peripheral surface of the second support member may each have a polygonal shape having an odd number of corners, but it is preferred that the outer peripheral surface of the first support member and the inner peripheral surface of the second support member each have a polygonal shape having an even number of corners. It is more preferred that the outer peripheral surface of the first support member and the inner peripheral surface of the second support member each have a hexagonal shape.

The intermediate support members may each have any shape as long as the intermediate support members can be arranged between the first support member and the second support member. However, for smooth movement of the first support member and the second support member in the axis direction and smooth rotation of the first support member and the second support member, it is preferred that the intermediate support members each have a spherical shape.

Moreover, the intermediate support members may be arranged at different positions in the axis direction. For example, when six intermediate support members are provided, three intermediate support members and another three intermediate support members may be arranged at different positions in the axis direction.

Moreover, a regulating portion configured to regulate axial positions of the intermediate support members may be provided.

According to another mode of the present invention, there is provided an optical-component driving apparatus. The optical-component driving apparatus includes: the above-mentioned optical-component supporting apparatus; a first drive mechanism configured to allow the second support member to linearly move in the axis direction relative to the first support member; and a second drive mechanism configured to allow the second support member to pivot around the first support member.

According to still another mode of the present invention, there is provided a camera apparatus. The camera apparatus includes: the above-mentioned optical-component driving apparatus; and an image sensor, a lens member, or the like mounted to the first support member or the second support member.

According to still another mode of the present invention, there is provided an electronic device. The electronic device includes the above-mentioned camera apparatus.

According to the present invention, a width of a space defined between the outer peripheral surface of the first support member and the inner peripheral surface of the second support member as seen from the axis direction is set so as to increase in the circumferential direction from the portions having the width that allows the intermediate support members to be sandwiched. Therefore, the linear movement along the optical axis direction and the pivoting action of the first support member or the second support member through the intermediate support members can be performed, thereby being capable of stabilizing a static posture and a dynamic posture of an optical component with respect to an optical axis.

### BRIEF DESCRIPTION OF THE DRAWINGS

FIG. 1 is a perspective view for illustrating an optical-component driving apparatus according to a first embodiment of the present invention.

FIG. 2 is an exploded perspective view for illustrating the optical-component driving apparatus according to the first embodiment of the present invention.

FIG. 3 is a plan view for illustrating an optical-component supporting apparatus according to the first embodiment of the present invention.

FIG. 4 is a sectional view for illustrating the optical-component supporting apparatus according to the first embodiment of the present invention.

FIG. 5 is a plan view for illustrating a state in which a first support member is rotated in a clockwise direction in the optical-component supporting apparatus according to the first embodiment of the present invention.

FIG. 6 is a plan view for illustrating a state in which the first support member is rotated in a counterclockwise direction in the optical-component supporting apparatus according to the first embodiment of the present invention.

FIG. 7 is a sectional view for illustrating a camera apparatus according to the first embodiment of the present invention.

FIG. 8 is a perspective view for illustrating an optical-component supporting apparatus according to a second embodiment of the present invention.

### DESCRIPTION OF THE EMBODIMENTS

Embodiments of the present invention are now described referring to the accompanying drawings.

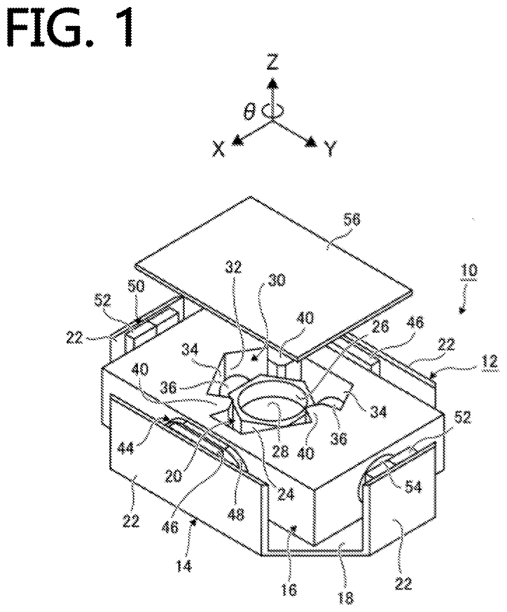

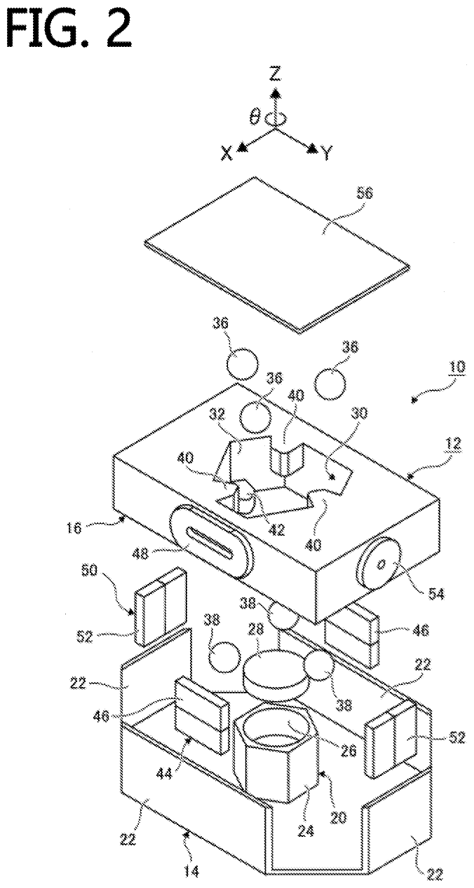

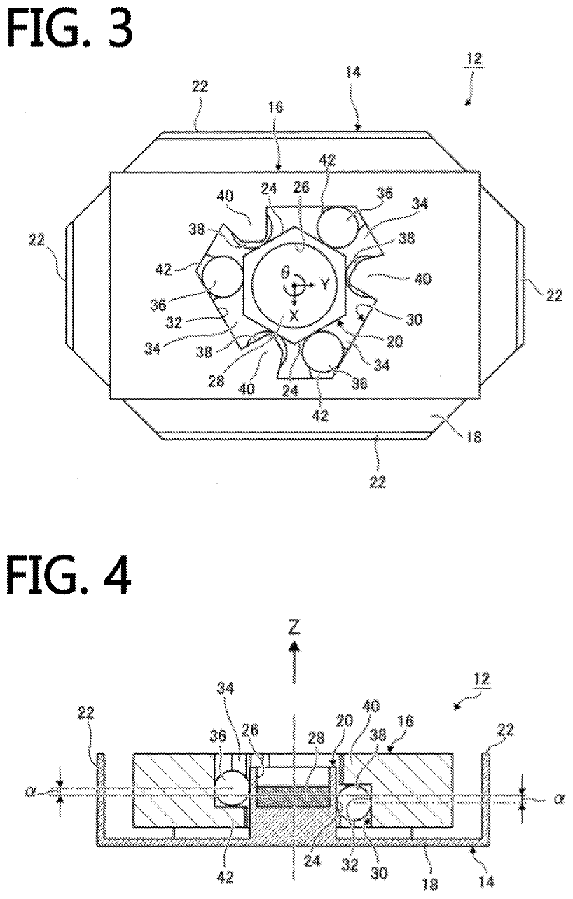

FIG. 1 and FIG. 2 are illustrations of an optical-component driving apparatus 10 according to a first embodiment of the present invention. FIG. 3 to FIG. 5 are illustrations of an optical-component supporting apparatus 12 which is a part of the optical-component driving apparatus 10.

In the description of this embodiment, an optical axis direction of an optical component described later is referred to as a Z direction, and directions orthogonal to the optical axis direction are referred to as an X direction and a Y direction, respectively (the X direction and the Y direction are orthogonal to each other). A direction around the optical axis is referred to as a θ direction. Moreover, light enters the optical component from a +Z side toward a −Z side. The +Z side corresponds to an upper side, and the −Z side corresponds to a lower side.

The optical-component supporting apparatus 12 includes a first support member 14 and a second support member 16. In this embodiment, the first support member 14 is a base forming a stator, and the second support member 16 is a movable member forming a mover. The optical component is mounted to the second support member 16.

The first support member 14 includes a bottom surface portion 18 having a plate shape. The bottom surface portion 18 has, for example, an octagonal shape which is long in the Y direction as seen from the optical axis direction. At a center of the bottom surface portion 18, a support column portion 20 is formed in such a manner as to project in the +Z direction. Moreover, upright walls 22 which stand in the +Z direction are formed on sides of the bottom surface portion 18 in the ±X directions and the ±Y directions, respectively. The support column portion 20 is provided at the center of the bottom surface portion 18 and is formed in such a manner as to project in the +Z direction.

The support column portion 20 has an outer peripheral surface 24. The outer peripheral surface 24 is formed of six flat surfaces which are parallel to the optical axis direction and has a regular hexagonal shape as seen from the optical axis direction. Moreover, an insertion hole 26 is formed at a center of the support column portion 20. The insertion hole 26 has a cylindrical shape and is parallel to the optical axis direction. A supporting magnet 28 having a circular column shape is inserted and fixed into the insertion hole 26. The supporting magnet 28 is magnetized in the optical axis direction.

The second support member 16 has a rectangular shape which is long in the Y direction as seen from the optical axis direction. The second support member 16 has a through hole 30. The through hole 30 has an inner peripheral surface 32. The inner peripheral surface 32 is formed of six flat surfaces which are parallel to the optical axis direction and has a hexagonal shape in which lengths of sides adjacent to each other as seen from the optical axis direction are different from each other. The support column portion 20 of the first support member 14 is inserted into the through hole 30 of the second support member 16 in such a manner that a part of a short side of the hexagonal shape (hereinafter referred to as a short side) of the inner peripheral surface 32 of the through hole 30 and a part of a long side (hereinafter referred to as a long side) adjacent to the short side are opposed to one side of the regular hexagonal shape of the outer peripheral surface 24 of the first support member 14.

Moreover, in spaces 34 defined between the outer peripheral surface 24 of the support column portion 20 of the first support member 14 and the inner peripheral surface 32 of the through hole 30 of the second support member 16, three upper intermediate support members 36 and three lower intermediate support members 38 are alternately inserted. The three upper intermediate support members 36 and the three lower intermediate support members 38 are formed of spherical members having the same shape. Moreover, the three upper intermediate support members 36 and the three lower intermediate support members 38 are each a soft magnetic member and are magnetized by the above-mentioned supporting magnet 28. For example, when an upper part of the above-mentioned supporting magnet 28 in the optical axis direction is magnetized into an N pole, and a lower part thereof is magnetized into an S pole, the three upper intermediate support members 36 and the three lower intermediate support members 38 are each magnetized in such a manner as to have the S pole on the upper side and the N pole on the lower side in the optical axis direction. The three upper intermediate support members 36 and the three lower intermediate support members 38 receive a force that acts in a direction toward the center of the first support member 14 by a magnetic force between the supporting magnet 28. At the same time, the three upper intermediate support members 36 and the three lower intermediate support members 38 are magnetized into the same pole, and hence a repulsive force acts on the upper intermediate support members 36 and the lower intermediate support members 38.

Moreover, the second support member 16 has three upper protrusions 40 formed apart at intervals of 120 degrees on an upper side of the through hole 30. The upper protrusions 40 project toward the support column portion 20 of the first support member 14 at portions at which the long side and the short side of the inner peripheral surface 32 of the second support member 16 intersect each other. The upper parts of the lower intermediate support members 38 are brought into abutment against lower surfaces of the three upper protrusions 40. The upper protrusions 40 form a regulating portion configured to regulate the movement of the lower intermediate support members 38 toward the upper side in the Z direction.

Moreover, the second support member 16 has three lower protrusions 42 formed apart at intervals of 120 degrees on a lower side of the through hole 30. The lower protrusions 42 project toward the support column portion 20 of the first support member 14 at portions at which the long side and the short side of the inner peripheral surface 32 of the second support member 16, which is a portion that the upper protrusions 40 are not provided, intersect each other. The lower parts of the upper intermediate support members 36 are brought into abutment against upper surfaces of the three lower protrusions 42. The lower protrusions 42 form a regulating portion configured to regulate the movement of the upper intermediate support members 36 toward the lower side in the Z direction.

As illustrated in FIG. 4, in the optical axis direction, the upper protrusions 40 and the lower protrusions 42 are formed so as to allow the upper intermediate support members 36 and the lower intermediate support members 38 to be offset. When the upper protrusions 40 and the lower protrusions 42 are not formed, a force acts to cause a center of the supporting magnet 28 in the optical axis direction and a center of each of the upper intermediate support members 36 in the optical axis direction to be set to the same height, and a force acts to cause the center of the supporting magnet 28 in the optical axis direction and a center of each of the lower intermediate support members 38 in the optical axis direction to be set to the same height. Therefore, the center of the supporting magnet 28 in the optical axis direction and the center of the upper intermediate support members 36 in the optical axis direction are set so as to have an offset α on an upper side in the optical axis direction, and the center of the supporting magnet 28 in the optical axis direction and the center of the lower intermediate support members 38 in the optical axis direction are set so as to have an offset α on a lower side in the optical axis direction. In a case in which the second support member 16 is moved relative to the first support member 14 upward or downward in the optical axis direction, when the drive force for the movement is eliminated, the second support member 16 returns to the positions of the offsets α.

As mentioned above, the outer peripheral surface 24 of the support column portion 20 of the first support member 14 has the regular hexagonal shape as seen from the optical axis direction. The inner peripheral surface 32 of the through hole 30 of the second support member 16 has the hexagonal shape as seen from the optical axis direction, in which sides thereof adjacent to each other are formed of the short side and the long side. The upper intermediate support members 36 and the lower intermediate support members 38 have the magnetic force acting thereon, which causes the repulsive force in the circumferential direction each other. As illustrated in FIG. 3, when a rotary force does not act on the first support member 14 from an outside, the upper intermediate support members 36 and the lower intermediate support members 38 are sandwiched in the spaces 34 defined between the outer peripheral surface 24 of the support column portion 20 of the first support member 14 and the inner peripheral surface 32 of the through hole 30 of the second support member 16. Regarding adjacent two of the upper intermediate support members 36 or the lower intermediate support members 38, a distance between two intermediate support members facing the short side is shorter than a distance between two intermediate support members facing the long side, and the two intermediate support members facing the short side have a higher repulsive force. Therefore, the repulsive force that acts on the upper intermediate support members 36 and the lower intermediate support members 38 facing the short side causes the upper intermediate support members 36 and the lower intermediate support members 38 to press the inner peripheral surface 32 corresponding to the long side of the second support member 16 in the opposite direction at the sandwiched position, thereby causing the second support member 16 to rest with respect to the first support member 14.

One outer peripheral surface 24 of the support column potion 20 of the first support member 14 mentioned above and a long side of the inner peripheral surface 32 opposed to the outer peripheral surface 24 of the through hole 30 of the second support member 16 form, for example, an angle of 30 degrees as seen from the optical axis direction. Thus, a width of the spaces 34 defined between the outer peripheral surface 24 of the support column portion 20 of the first support member 14 and the inner peripheral surface 32 of the through hole 30 of the second support member 16 as seen from the optical axis direction gradually increases from the portions at which the upper intermediate support member 36 and the lower intermediate support member 38 are sandwiched toward the circumferential direction.

That is, the width of the spaces 34 described above gradually increases toward the clockwise direction from the portions at which the upper intermediate support members 36 are sandwiched, and the width of the spaces 34 gradually increases toward the counterclockwise direction from the portions at which the lower intermediate support members 38 are sandwiched.

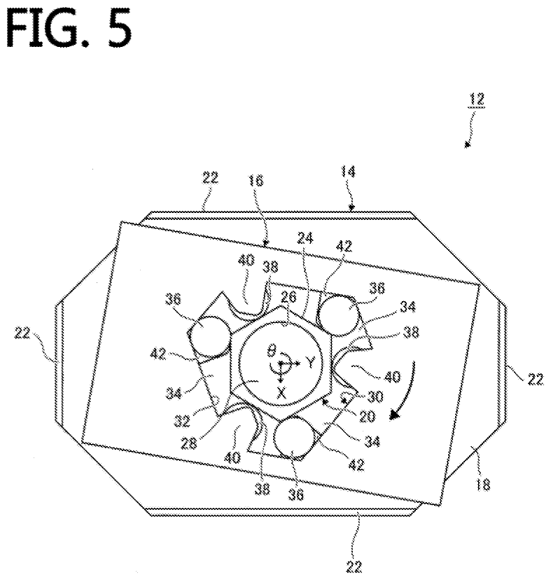

Thus, as illustrated in FIG. 5, when a drive force in the clockwise direction is applied to the second support member 16, the upper intermediate support members 36 are pressed in the clockwise direction by the outer peripheral surface 24 of the support column portion 20 of the first support member 14 and the inner peripheral surface 32 of the through hole 30 of the second support member 16 to be moved to portions of the spaces 34 having a larger width. On the other hand the lower intermediate support members 38 are pushed by the repulsive force generated by the magnetic force of the upper intermediate support members 36 and moved while abutting against the inner peripheral surface 32. When the upper intermediate support members 36 are brought into abutment against the inner peripheral surface 32 corresponding to the short sides, the upper intermediate support members 36 cannot move further.

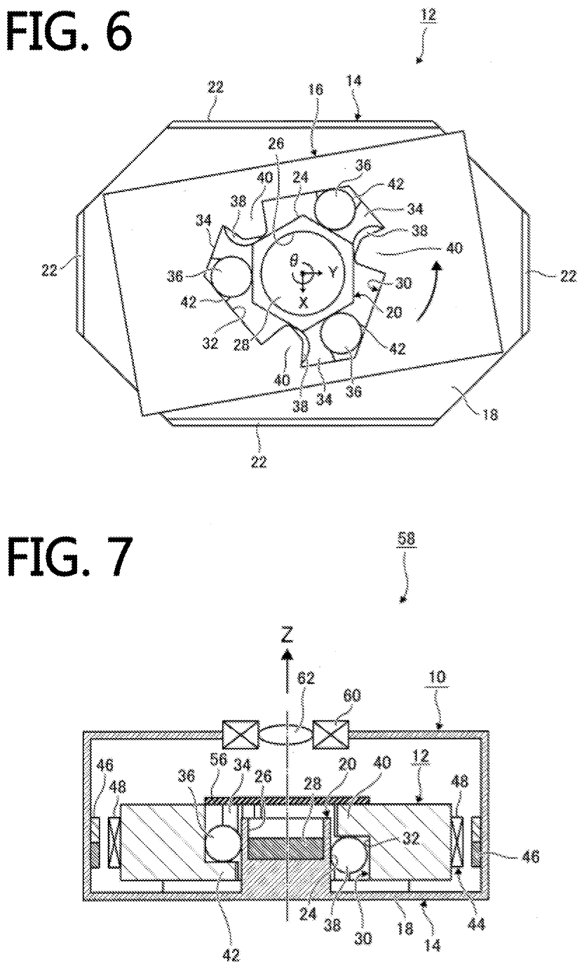

On the other hand as illustrated in FIG. 6, when the drive force in the counterclockwise direction is applied to the second support member 16, the lower intermediate support members 38 are pressed in the counterclockwise direction by the outer peripheral surface 24 of the support column portion 20 of the first support member 14 and the inner peripheral surface 32 of the through hole 30 of the second support member 16 and moved to portions of the spaces 34 having a larger width. The upper intermediate support members 36 are pushed by the repulsive force generated by the magnetic force of the lower intermediate support members 38 and moved while abutting against the inner peripheral surface 32. Then, when the lower intermediate support members 38 are brought into abutment against the inner peripheral surface 32 corresponding to the short sides, the lower intermediate support members 38 cannot move further.

Regarding the rotation of the second support member 16, the second support member 16 may be brought into abutment against the upright walls 22 of the first support member 14 so that the upright walls 22 function as stoppers with respect to the second support member 16.

Next, a drive mechanism for driving the second support member 16 is described.

A first drive mechanism 44 is a mechanism for driving the second support member 16 in the Z direction relative to the first support member 14.

The first drive mechanism 44 includes two Z-direction drive magnets 46 and two Z-direction drive coils 48. The two Z-direction drive magnets 46 are provided on inner surfaces of the upright walls 22 located on both sides of the first support member 14 in the X direction. The two Z-direction drive coils 48 are provided on outer surfaces of the second support member 16 so as to be opposed to the Z-direction drive magnets 46 with a gap. The Z-direction drive magnets 46 are each magnetized in the X direction and separated into opposite magnetic poles in the Z direction to generate a magnetic field in the ±X directions. An electric current flows through the Z-direction drive coils 48 in the ±Y directions. When the electric current is applied through the Z-direction drive coils 48, a Lorentz force acts on the Z-direction drive coils 48 in the Z direction to cause the second support member 16 to move in the Z direction. When the energization of the Z-direction drive coils 48 is interrupted, the magnetic force acting between the supporting magnet 28 and each of the upper intermediate support members 36 and the lower intermediate support members 38 as mentioned above causes the second support member 16 to return to an original position illustrated in FIG. 4.

A second drive mechanism 50 is a mechanism for rotating the second support member 16 in the θ direction relative to the first support member 14.

The second drive mechanism 50 includes two θ-direction drive magnets 52 and two θ-direction drive coils 54. The two θ-direction drive magnets 52 are provided on inner surfaces of the upright walls 22 located on both sides of the first support member 14 in the Y direction. The two θ-direction drive coils 54 are provided on outer surfaces of the second support member 16 so as to be opposed to the θ-direction drive magnets 52 with a gap. The θ-direction drive magnets 52 are each magnetized in the Y direction and separated into opposite magnetic poles in the X direction to generate a magnetic field in the ±Y directions. An electric current flows through the θ-direction drive coils 54 in the ±Z directions. When the electric current is applied through the θ-direction drive coils 54, a Lorentz force acts on the θ-direction drive coils 54 in the X direction to cause the second support member 16 to move in the θ direction by component force. When the energization of the θ-direction drive coils 54 is interrupted, the second support member 16 remains at that position.

An image sensor 56, which is an optical component, is fixed to an upper surface of the second support member 16. When the optical-component driving apparatus 10 performs the up-and-down movement in the Z direction and the rotation in the θ direction, the image sensor 56 can also perform the up-and-down movement in the Z direction and the rotation in the θ direction.

In the embodiment described above, the first support member 14 serves as a stator, and the second support member 16 serves as a mover. However, the first support member 14 may serve as a mover, and the second support member 16 may serve as a stator. In this case, the image sensor 56 is fixed to the first support member 14. Moreover, optical components such as a lens and a prism can be mounted in addition to the image sensor 56.

FIG. 7 is an illustration of a camera apparatus 58 using the optical-component driving apparatus 10 described above. The camera apparatus 58 includes an axis-orthogonal-direction drive mechanism 60 fixed to the first support member 14. A lens member 62 is mounted to the axis-orthogonal-direction drive mechanism 60. The axis-orthogonal-direction drive mechanism 60 is configured to, for example, support the lens member 62 with use of a spring and drive the lens member 62 in the XY direction with use of a coil and a magnet. The lens member 62 is configured to focus light from an object to the above-mentioned image sensor 56.

In the camera apparatus 58, the first support member 14 is moved in the Z direction by the above-mentioned first drive mechanism 44 to focus the lens member 62 with respect to the image sensor 56, and image stabilization is performed with use of the second drive mechanism 50 and the axis-orthogonal-direction drive mechanism 60.

In this embodiment, positions of the first drive mechanism 44 and the second drive mechanism 50 may be replaced. Moreover, positions of the Z-direction drive magnets 46 and the Z-direction drive coils 48 may be replaced, and positions of the θ-direction drive magnets 52 and the θ-direction drive coils 54 may be replaced. Moreover, the axis-orthogonal-direction drive mechanism 60 may be the one using a piezoelectric element or a shape memory alloy.

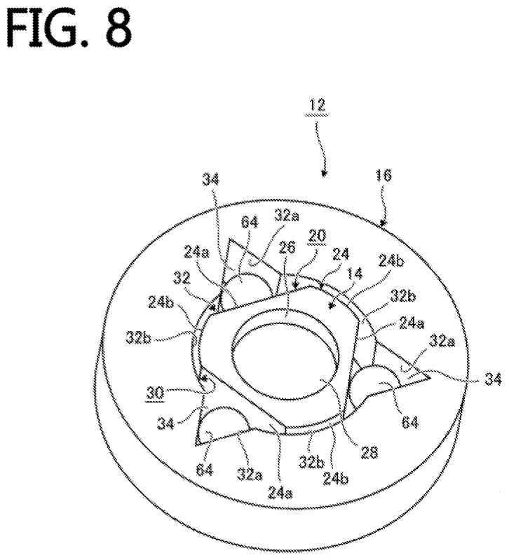

FIG. 8 is an illustration of the optical-component supporting apparatus 12 according to a second embodiment of the present invention.

In the second embodiment, the support column portion 20 of the first support member 14 has a triangular shape as seen from the optical axis direction and has rounded corners. Similarly to the first embodiment mentioned above, the support column portion 20 has the insertion hole 26, which is parallel to the optical axis direction and has a cylindrical shape. The supporting magnet 28 having a circular column shape is inserted and fixed into the insertion hole 26. The supporting magnet 28 is magnetized in the optical axis direction similarly to the first embodiment. Moreover, the outer peripheral surface 24 of the support column portion 20 which is parallel to the optical axis direction is formed of three flat surface portions 24a and curved surface portions 24b each formed between the flat surface portions 24a.

The second support member 16 has a circular shape as seen from the optical axis direction. The second support member 16 has the through hole 30 having a triangular shape as seen from the optical axis direction. The inner peripheral surface 32 forming the through hole 30 includes three intermediate-support-member insertion portions 32a and three recess portions 32b. The three intermediate-support-member insertion portions 32a each have an isosceles triangle shape as seen from the optical axis direction. The three recess portions 32b each have an arc shape and connect the intermediate-support-member insertion portions 32a. The flat surface portions 24a of the outer peripheral surface 24 of the first support member 14 are opposed to the intermediate-support-member insertion portions 32a of the inner peripheral surface 32 of the second support member 16, and the curved surface portions 24b of the outer peripheral surface 24 of the first support member 14 are opposed to the recess portions 32b of the inner peripheral surface 32 of the second support member 16 with a gap.

Three intermediate support members 64 each having a spherical shape are formed of a soft magnetic member similarly to the above-mentioned first embodiment and are arranged in the spaces 34 defined between the flat surface portions 24a of the outer peripheral surface 24 of the first support member 14 and the intermediate-support-member insertion portions 32a of the inner peripheral surface 32 of the second support member 16.

Similarly to the first embodiment mentioned above, the three intermediate support members 64 are attracted toward the first support member 14 side by the supporting magnet 28, and the intermediate support members 64 repel each other. Similarly to the first embodiment mentioned above, the spaces 34 are each defined in such a manner that a width as seen from the optical axis direction increases in the circumferential direction from portions at which the intermediate support members 64 are sandwiched. Description is made of a case in which the second support member 16 is rotated in the clockwise direction in FIG. 8. The intermediate support members 64 are brought into contact with the flat surface portions 24a at respective center portions of the flat surface portions 24a and are brought into contact with the intermediate-support-member insertion portions 32a on the left side as seen from the center of the supporting magnet 28. The intermediate support members 64 are not brought into contact with the intermediate-support-member insertion portions 32a on the right side. When the second support member 16 starts rotating in the clockwise direction, the intermediate support members 64 are pushed by the intermediate-support-member insertion portions 32a on the left side and move rightward on the flat surface portions 24a. The second support member 16 can rotate until the intermediate support members 64 are brought into contact with the flat surface portions 24a, the intermediate-support-member insertion portions 32a on the left side, and the intermediate-support-member insertion portions 32a on the right side. When the second support member 16 is rotated in the counterclockwise direction in this state, the intermediate support members 64 are pushed by the intermediate-support-member insertion portions 32a on the right side to move leftward on the flat surface portions 24a.

Thus, when the drive force in the optical axis direction acts on the second support member 16 from the outside, the second support member 16 moves in the optical axis direction relative to the first support member 14 through the intermediate support members 64. Slightly different from the first embodiment mentioned above, protrusion portions may be provided on an upper side and a lower side of one space 34 of the through hole 30 to sandwich the intermediate support member 64 from the upper side and the lower side so that the second support member 16 can return to the original position when the drive force is eliminated.

Moreover, when the drive force in the circumferential direction acts on the second support member 16 from the outside, the second support member 16 moves in the circumferential direction relative to the first support member through the intermediate support members 64. That is, depending on the rotating direction, the intermediate support members 64 rotate in association with the rotation of the second support member 16 or substantially keep respective positions, allowing the rotation of the second support member 16. When the drive force in the rotating direction is eliminated, the second support member 16 remains at that position.

What is claimed is:

1. An optical-component supporting apparatus, comprising:
a supporting magnet, which has a columnar shape, and is magnetized in an axis direction;
a first support member, which has the supporting magnet fixed at a center, and includes an outer peripheral surface parallel to the axis direction;
a second support member, which is provided around the first support member, and includes an inner peripheral surface that is opposed to the first support member and is parallel to the axis direction; and
intermediate support members, which are inserted into a space defined between the outer peripheral surface of the first support member and the inner peripheral surface of the second support member, and are magnetized by the supporting magnet,
wherein a width of the space as seen from the axis direction increases in a circumferential direction from portions having a width that allows the intermediate support members to be sandwiched.

2. The optical-component supporting apparatus according to claim 1,
wherein, in the first support member, the outer peripheral surface of the first support member has a regular polygonal shape as seen from the axis direction, and
wherein, in the second support member, the inner peripheral surface of the second support member has a polygonal shape as seen from the axis direction, in which lengths of sides adjacent to each other are different from each other and in which the number of corners is the same as the number of corners of the outer peripheral surface of the first support member.

3. The optical-component supporting apparatus according to claim 2, wherein the outer peripheral surface of the first support member has a regular polygonal shape having an even number of corners as seen from the axis direction.

4. The optical-component supporting apparatus according to claim 1,
wherein, in the first support member, the outer peripheral surface of the first support member has a polygonal shape as seen from the axis direction, in which lengths of sides adjacent to each other are different from each other, and
wherein, in the second support member, the inner peripheral surface of the second support member has a regular polygonal shape as seen from the axis direction, in which the number of corners is the same as the number of corners of the outer peripheral surface of the first support member.

5. The optical-component supporting apparatus according to claim 4, wherein the inner peripheral surface of the second support member has a regular polygonal shape having an even number of corners as seen from the axis direction.

6. The optical-component supporting apparatus according to claim 1, wherein the intermediate support members each have a spherical shape.

7. The optical-component supporting apparatus according to claim 6, wherein the intermediate support members adjacent to each other are different in axial positions.

8. The optical-component supporting apparatus according to claim 1, wherein one of the first support member and the second support member includes a regulating portion configured to regulate movement of the intermediate support members in the axis direction.

9. An optical-component supporting apparatus, comprising:
a supporting magnet, which has a circular column shape, and is magnetized in an axis direction;
a first support member, which has the supporting magnet fixed at a center, includes six outer peripheral surfaces parallel to the axis direction, and has a regular hexagonal shape as seen from the axis direction;
a second support member, which is provided around the first support member, includes six inner peripheral surfaces that are opposed to the first support member and are parallel to the axis direction, and has a hexagonal shape as seen from the axis direction, in which long sides and short sides are alternately formed; and
at least six intermediate support members, which are inserted into spaces defined between the outer peripheral surface of the first support member and the inner peripheral surface of the second support member, and are magnetized by the supporting magnet,
wherein a width of the spaces as seen from the axis direction increases in the circumferential direction from portions having a width that allows the intermediate support members to be sandwiched.

10. The optical-component supporting apparatus according to claim 9,
wherein the intermediate support members each have a spherical shape and include three front intermediate support members and three rear intermediate support members, and
wherein the front intermediate support members and the rear intermediate support members are arranged at different positions in the axis direction.

11. An optical-component driving apparatus, comprising:
the optical-component supporting apparatus of claim 1;
a first drive mechanism configured to allow the second support member to linearly move in the axis direction relative to the first support member; and
a second drive mechanism configured to allow the second support member to pivot around the first support member.

12. An optical-component driving apparatus, comprising:
the optical-component supporting apparatus of claim 9;
a first drive mechanism configured to allow the second support member to linearly move in the axis direction relative to the first support member; and
a second drive mechanism configured to allow the second support member to pivot around the first support member.

13. A camera apparatus, comprising:
the optical-component driving apparatus of claim 12; and
an image sensor mounted to the second support member.

14. The camera apparatus according to claim 13, further comprising:
an axis-orthogonal-direction drive mechanism provided to the first support member; and
a lens member mounted to the first support member,
wherein light from an object passes through the lens member to focus on the image sensor.

15. An electronic device comprising the camera apparatus of claim 13.

16. An electronic device comprising the camera apparatus of claim 14.
